(19) United States
(12) Patent Application Publication
(10) Pub. No.: US 2018/0033395 A1
(43) Pub. Date: Feb. 1, 2018

(54) DISPLAY DEVICE AND METHOD FOR USING THE SAME

(71) Applicant: BOE TECHNOLOGY GROUP CO., LTD, Beijing (CN)

(72) Inventor: Katsuhiro MASUYAMA, Beijing (CN)

(21) Appl. No.: 15/509,595

(22) PCT Filed: Aug. 12, 2016
(86) PCT No.: PCT/CN2016/094809

§ 371 Date: Mar. 8, 2017

(30) Foreign Application Priority Data
Dec. 11, 2015 (CN) 201510920906.X

(51) Int. Cl. G09G 5/02; G09G 5/00

(52) U.S. Cl. CPC G09G 5/02; G09G 5/003; G09G 2320/0242; G09G 2360/145

(57) ABSTRACT

The present disclosure provides a display device, including: at least two display modules connected jointly; a controller; and at least one color sensor for detecting spectrum signals and brightness signals of each display module. The controller is configured to receive the spectrum signals and brightness signals of each display module and provide image signal processing parameters for each display module.

### CROSS-REFERENCES TO RELATED APPLICATIONS

This PCT patent application claims priority of Chinese Patent Application No. 201510920906.X, filed on Dec. 11, 2015, the entire content of which is incorporated by reference herein.

### TECHNICAL FIELD

The present invention generally relates to the display technologies and, more particularly, relates to a display device and a method for using the display device.

### BACKGROUND

A transparent display device often refers to a display device that appears to be optically transparent so that viewers can see the objects behind the display device. Transparent display devices are commonly used where objects behind the display devices need to be seen. For example, transparent display devices may be used as show windows. However the colors and brightness of the images displayed by a conventional display device lack uniformity. The display device may have impaired display quality.

### BRIEF SUMMARY

The present disclosure provides a display device and a method for operating the display device. The device and method are directed to improve the impaired display quality of display devices, caused by non-uniformities in the spectra and brightness of the transparent display devices, in response to backlight.

One aspect of the present disclosure includes a display device, including: at least two display modules connected jointly; a controller; and at least one color sensor for detecting spectrum signals and brightness signals of each display module. The controller is configured to receive the spectrum signals and brightness signals of each display module and provide image signal processing parameters for each display module.

Optionally, the display device further includes at least one image signal processing circuit connected to the controller and the at least two display modules, wherein the at least one image signal processing circuit is configured to receive image signal processing parameters from the controller and adjust the image signals of each display module.

Optionally, the display device further includes at least two image signal processing circuits, the at least two display modules and the at least two image signal processing circuits forming a one-to-one correspondence. Tach image signal processing circuit is connected to a corresponding display module; and each of the image signal processing circuits is configured to receive image signal processing parameters from the controller and adjust the image signals of the corresponding display module.

Optionally, the image signal processing circuit includes a white balance adjustment circuit, a brightness adjustment circuit, and a color adjustment circuit, being independent from one another, the white balance adjustment circuit adjusting red/green/blue gains of a display module, the brightness adjusting a brightness value of a display module, and the color adjustment circuit adjusting a color value of a display module.

Optionally, the at least two display modules include at least a transparent display module.

Optionally, the display device limber includes: a directional lens between a color sensor and a display module, the color sensor detects the spectrum signals and brightness signals of the display module.

Optionally, a detecting part of each color sensor faces a same direction.

Optionally, the spectrum signals and brightness signals of each display module detected by the at least one color sensor are generated by each display module in response of backlight of the display device.

Optionally, the display device according further includes at least two color sensors forming a one-to-one correspondence with the at least two display modules, wherein each color sensor detects the spectrum signals and brightness signals of a corresponding display module.

Optionally, a color sensor is arranged on a peripheral side of the corresponding display module.

Optionally, color sensors are arranged on a same peripheral side of the corresponding display modules.

Optionally, the display device further includes a backlight module having a light guide plate. The light guide plate is arranged on a light incident side of the at least two display modules.

Optionally, the backlight module further includes a light source. The light source is disposed on one or more peripheral sides of the light guide plate; and the light source includes a plurality of lighting stripes formed by dot-shaped illuminators.

Another aspect of the present disclosure provides a method for operating the disclosed display device, including: detecting spectrum signals and brightness signals of each transparent display module; based on the detected spectrum signals and brightness signals of each transparent display module, obtaining image signal processing parameters of each transparent display module for adjusting image signals of each transparent display module; and based on the image signal processing parameters of each transparent display module, adjusting the image signals of each transparent display module.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary display device according to various disclosed embodiments of the present disclosure;

FIG. 2 illustrates a structure of an exemplary directional color sensor used in the display device illustrated in FIG. 1 according to various disclosed embodiments of the present disclosure;

FIG. 3 illustrates exemplary spectrum signals received by a transparent display module located at region C of the display device illustrated in FIG. 1 according to various disclosed embodiments of the present disclosure;

FIG. 4 illustrates actually detected R/G/B gain of a transparent display module located at region C of the display device illustrated in FIG. 1 according to various disclosed embodiments of the present disclosure;

FIG. 5 illustrates a compensation curve of the actually-detected R/G/B gain illustrated in FIG. 4 according to various disclosed embodiments of the present disclosure;

FIG. 6 illustrates an exemplary process for controlling the transparent display module according to various disclosed embodiments of the present disclosure;

FIG. 7 illustrates another exemplary process for controlling the transparent display module according to various disclosed embodiments of the present disclosure;

FIG. 8 illustrates another exemplary process for controlling the transparent display module according to various disclosed embodiments of the present disclosure;

FIG. 9 illustrates a block diagram of an exemplary controller used according to various disclosed embodiments of the present disclosure; and

FIG. 10 illustrates an exemplary block diagram of certain parts according to various disclosed embodiments of the present disclosure.

### DETAILED DESCRIPTION

For those skilled in the art to better understand the technical solution of the invention, reference will now be made in detail to exemplary embodiments of the invention, which are illustrated in the accompanying drawings. Wherever possible, the same reference numbers will be used throughout the drawings to refer to the same or like parts.

As used herein, the term “spectrum signals and brightness signals” of a transparent/opaque display module refers to spectrum signals and brightness signals, generated by the transparent/opaque display module, in response to backlight of the display device containing the transparent/opaque display modules.

In a conventional transparent display device, a light source is often disposed on a peripheral side of a light guide plate, and the light guide plate is combined or bonded with a transparent display module. An upper polarizer and a lower polarizer are often used to rotate the polarization of light incident on the liquid crystal layer of the transparent display module. The upper polarizer and the lower polarizer also delay light of a certain polarization to be incident on the liquid crystal layer. By controlling the polarizations of light that passes through the upper polarizer and the lower polarizer, the display panel can be controlled to be operated under normal black mode for displaying images and normal white mode for appearing transparent.

Currently, a large-area transparent display device is often formed by jointly connecting a plurality of transparent display modules. The image signals of an image for display are divided into a plurality of parts by an image divider. The parts are transmitted to different transparent display modules for display. For a large-area transparent display device, because the light source is alien disposed on the peripheral side of the light guide plate, the plurality of transparent display modules may thus receive backlight of different spectra and brightness. As a result, the colors and brightness of the images displayed by different transparent display modules lack uniformity. The large-area transparent display device may have impaired display quality.

One aspect of the present disclosure provides a display device.

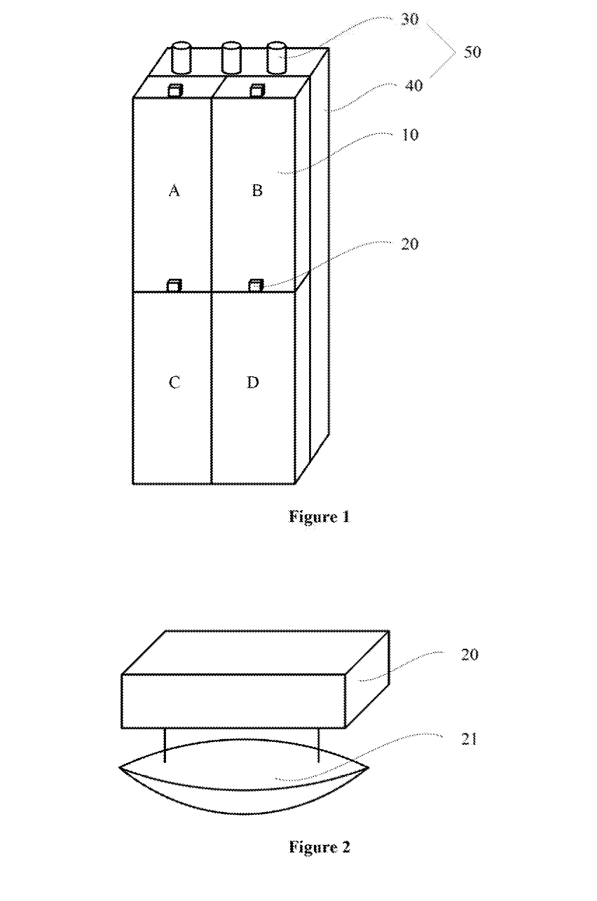

FIG. 1 illustrates an exemplary display device according to various embodiments of the present disclosure. As shown in FIG. 1, the display device may include at least two transparent display modules 10, jointly connected with each other. The display device may also include color sensors 20. The color sensors 20 may detect the spectrum signals and brightness signals received by each transparent display module 10. The display device may further include a controller (not shown). The controller may be connected with the color sensors 20. Based on the spectrum signals and brightness signals of each transparent display module 10, detected by the color sensors 10, the controller may obtain image signal processing parameters for each transparent display module 10. The image signal processing parameters are used for adjusting the image signals of each transparent display module 10. The controller may adjust the image signals of each transparent display module 10 based on the image signal processing parameters for each transparent display module 10.

In some embodiments, the image display region of the display device may be formed by two or more jointly-connected transparent display modules 10. In some embodiments, the display device may include a backlight module 50. The backlight module 50 may include a light source 30 and a light guide plate 40. For example, the number of transparent display modules 10 forming the display device may be two, three, four, etc. While the image display region of the display device is formed by two or more transparent display modules 10, the arrangement of other certain related parts, such as the light source 30 and the color sensors 20, may remain unchanged. For illustrative purposes, embodiments of the present disclosure are illustrated in detail using a display device including four jointly-connected transparent display modules 10 as an example.

In some embodiments, as shown in FIG. 1, the display device may be formed by four jointly-connected transparent display modules 10. The display device may be formed by four transparent display modules 10 arranged in four regions, i.e., regions A, B, C, and D. A light guide plate 40 may be arranged at the light incident side of the four transparent display modules 10. That is, the light guide plate 40 may be arranged behind, e.g., on the back of, the four transparent display modules 10, as shown in FIG. 1. The light source 30 may be disposed on one or more peripheral sides of the light guide plate 40. The light source 30 may include a plurality of lighting stripes formed by dot-shaped illuminators. For example, some dot-shaped illuminators may be arranged along a peripheral side of the light guide plate 40 to form a light stripe, as shown in FIG. 1. A color sensor 20 may be arranged on a peripheral side of a transparent display module 10. The color sensors 20 may be connected with the controller through control signal lines. The communication between the color sensors 20 and the controller may be implemented through the control signal lines. For example, a color sensor 20 may send detected spectrum signals and brightness signals to the controller through the control signal line, and/or the controller may send certain control signals to a color sensor 20 so that the color sensor 20 may start detecting the spectrum signals and brightness signals of a transparent display module 10.

When the disclosed display device is displaying images, the light source 30 may provide backlight for the display device. The backlight may be incident on the hack of each transparent display module 10. The color sensors 20 may detect the spectrum signals and brightness signals of each transparent display module 10, in response to the backlight. The color sensors 20 may send the spectrum signals and brightness signals of each transparent display module 10 to the controller. Based on the detected spectrum signals and brightness signals of each transparent display module 10, the controller may calculate the image signal processing parameters for each transparent display module 10. Further, the controller may use the image signal processing parameters for adjusting the image signals of each transparent display module 10.

In the present disclosure, the image signals of a transparent display module 10 may include the actually-detected R/G/B gains, the brightness value, the color value, and other suitable values of the transparent display module 10. Accordingly, the image signal processing parameters, for adjusting the image signals, may include white balance adjustment parameters, brightness adjustment parameters, color adjustment parameters, and other suitable adjustment parameters. In some embodiments, each of these adjustment parameters may include compensation values/curves used for compensating a certain image signal of a transparent display module 10 so that the compensated image signal may match or be in accordance with the same image signals of other transparent display modules 10. In various embodiments, the term “compensation” means “correction” or the alike.

For example, based on the spectrum signal and brightness signal of each transparent display module 10, detected by the color sensors 20, the controller may calculate the white balance adjustment parameters used for adjusting the white balance of each transparent display module 10, the brightness adjustment parameters used for adjusting the brightness of each transparent display module 10, and the color adjustment parameters used for adjusting color of each transparent display module 10. Further, based on the image signal processing parameters, e.g., the white balance adjustment parameters, the brightness adjustment parameters, and the color adjustment parameters, for each transparent display module, the controller may adjust the image signals of each transparent display module 10.

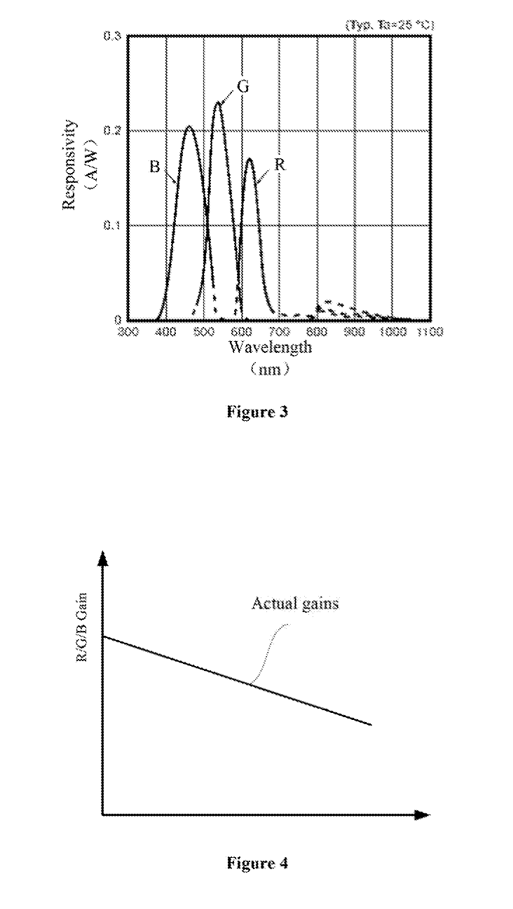

For example, the controller may adjust the white balance of a transparent display module 10. The color sensors 20 may detect the spectrum signals and brightness signals of the transparent display module 10 positioned in the region C of FIG. 1. The color sensors 20 may also detect the spectrum signals and brightness signals received by other transparent display modules 10 positioned in other regions, e.g., regions A, B, and D. In one example, spectrum signals of the transparent display module 10 are shown in FIG. 3. In FIG. 3, the x axis represents the wavelengths, and the y axis represents the photo-sensitivity or photo-responsivity of the transparent display module 10 as a function of wavelength, R represents red color, G represents green color, and B represents blue color.

The color sensors 20 may detect the spectrum signals and brightness signals of each transparent display module 10 and send the detected signals to the controller. Based on the detected spectrum signals and brightness signals of the four exemplary transparent display modules 10, the controller may obtain the actually-detected red/green/blue (R/G/B) gains of the transparent display module 10 positioned at region C. The controller may also obtain the actually-detected. R/G/B gains of the transparent display modules 10 positioned at regions A and B. For example, the actually-detected R/G/B gains of the transparent display module 10 positioned at region C is shown in FIG. 4.

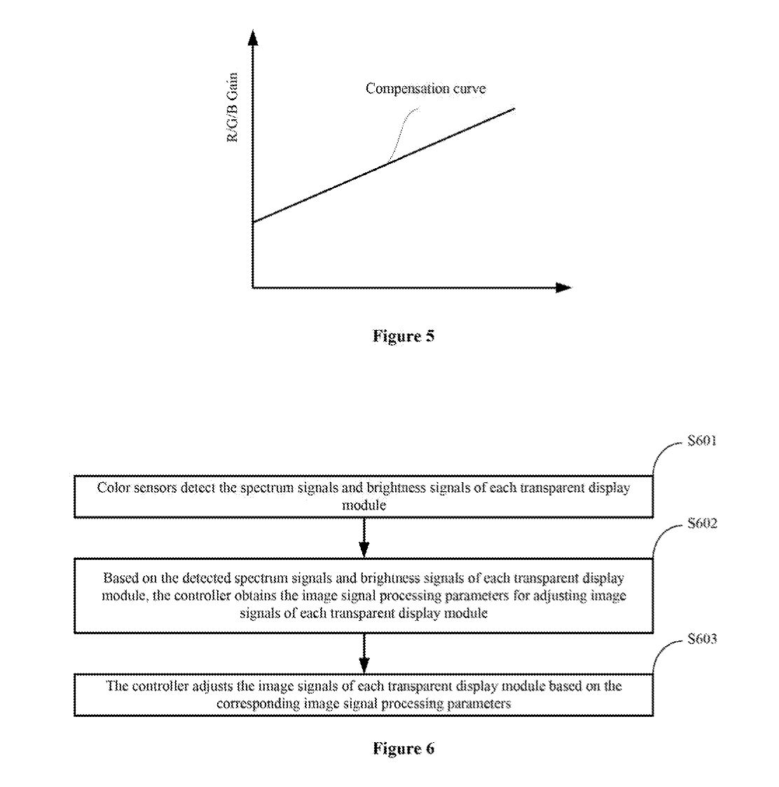

Based on the actually detected R/G/B gains of the transparent display modules 10 positioned at regions A, B, and C, and the actually detected R/G/B gains of the transparent display module 10 positioned at region C, the controller may calculate a compensation curve or correction curve for the actually-detected R/G/B gains of the transparent display module 10 positioned at region C. The compensation curve may include a plurality of compensation values corresponding to the actually-detected R/G/B gains of the transparent display module 10, as shown in FIG. 5.

As shown in FIG. 4, for example, the actually detected R/G/B gains of the transparent display module 10 positioned at region C may be undesirably low or may decrease as a function of x-axis. The controller may compensate the R/G/B gains of the transparent display module 10 positioned at region C to increase the R/G/B gains of the transparent display module 10 positioned at region C as shown in FIG. 5. The compensation values to the actually-detected R/G/B gains of the transparent display module 10 positioned at region C. An exemplary compensation curve for the R/G/B gains of the transparent display module 10 positioned at region C, generated by the controller, is shown in FIG. 5. Based on the compensation curve shown in FIG. 5, the controller may adjust the R/G/B gains of the transparent display module 10 positioned at region C such that the adjusting of the white balance of this transparent display module 10 may be implemented. Thus, the white balance of the transparent display module 10 positioned at region C may match or be in accordance with the white balance of other transparent display modules 10.

Similarly, when the controller adjusts other image signals, e.g., brightness signals and color signals, of a transparent display module 10, the process and method may be the same as the adjusting of white balance described above. For example, when adjusting the brightness of the transparent display modules 10, the controller may obtain the actually detected brightness value of each transparent display module 10 based on the spectrum signals and brightness signals of each transparent display module 10 detected by the color sensors 20. The controller may further determine the brightness compensation value to compensate the actually-detected brightness value and adjust the brightness of each transparent display module 10. For example, if the actually-detected brightness value of the transparent display module 10 positioned at region C, detected by the color sensors 20, is lower than the actually-detected brightness values of the transparent display modules 10 in other regions, the controller may determine the brightness compensation value to compensate the actually-detected brightness value and adjust the brightness of the transparent display module 10 positioned at region C. After the controller adjusts the brightness of the transparent display module 10 positioned at region C, the brightness of this transparent display module 10 may match or be in accordance with the brightness of other transparent display modules 10.

Also, when adjusting the color of the transparent display modules 10, the controller may obtain the actually-detected color value of each transparent display module 10 based on the spectrum signals and brightness signals of each transparent display module 10 detected by the color sensors 20. The controller may further determine the color compensation value for adjusting the color of each transparent display module 10. For example, if the actually-detected color value of the transparent display module 10 positioned at region C, detected by the color sensors 20, is lower than the actually-detected brightness values of the transparent display modules 10 in other regions, the controller may determine the color compensation value for the actually-detected color value and adjust the color of the transparent display module 10 positioned at region C. After the controller adjusts the color of the transparent display module 10 positioned at region C, the color of this transparent display module 10 may match or be in accordance with the colors of other transparent display modules 10.

Thus, in the disclosed display device, the color sensors 20 may detect the spectrum signals and brightness signals of each transparent display module 10. The color sensors 20 may send the spectrum signals and brightness signals of each transparent display module 10 to the controller. Based on the spectrum signals and brightness signals of each transparent display module 10, detected by the color sensors 20, the controller may calculate the image signal processing parameters for adjusting image signals of each transparent display module 10. The controller may adjust the image signals of each transparent display module 10 based on the corresponding image signal processing parameters. Accordingly, the image signals of each transparent display module 10 may match or be in accordance with the image signals of other transparent display modules 10.

In the disclosed display device, by combining the use of the color sensors 20 and the controller, the image signals of each transparent display module 10 may be adjusted. Accordingly, the image signals of each transparent display module 10 may match or be in accordance with the image signals of other transparent display modules 10. That is, the color and brightness of the images displayed by each transparent display module 10 may have improved uniformity. Non-uniformities of the color and brightness in the images displayed by different transparent display modules 10 may be reduced or eliminated. The display quality of the display device may be improved.

Further, in the disclosed display device, by combining the use of the color sensors 20 and the controller, the image signals of each transparent display module 10 may be adjusted. The image reproducibility of the display device may be improved. Meanwhile, the color and brightness of the images displayed by each transparent display modules 10 may have improved uniformity. Brightness Mura of the display device may be reduced.

In some embodiments, the image display region of the display device may be formed by a plurality of transparent display modules. In some other embodiments, a plurality of opaque display modules may be arranged in the image display region of the display device. A plurality of color sensors may be disposed in the opaque display modules to detect the spectrum signals and brightness signals of each opaque display module. The controller may adjust the white balance, the brightness, and the color of each opaque display module to improve the display quality of the display device. In certain other embodiments, the image display region may contain at least one transparent display module and at least one opaque display module. Color sensors may be disposed in the transparent display modules and the opaque display modules to detect the spectrum signals and brightness signals of each transparent display module and each opaque display module. The controller may adjust the white balance, brightness, and color of each transparent display module and each opaque display module to improve the display quality of the display device.

It should be noted that, in the present disclosure, the term “display device” may represent. a display device that can contain only a plurality of transparent display modules, only a plurality of opaque display modules, or a combination of some transparent display modules and some opaque display modules. For illustrative purposes, only transparent display modules are described in detail in the embodiments of the present disclosure. The working principles of a display device with only opaque display modules, or a combination of transparent display modules and some opaque display modules are similar to the working principles of a display device with only transparent display modules, and are not repeated herein.

In various embodiments of the present disclosure, one or more color sensors 20 may be used in the display device. Each color sensor 20 may be configured to detect the spectrum signals and brightness signals of at least one transparent display module 10. In one embodiment, one color sensor 20 may be disposed in the display device shown in FIG. 1. The one color sensor 20 may be configured to detect the spectrum signals and brightness signals of four transparent display modules 10. In another embodiment, two color sensors 20 may be disposed in the display device shown in FIG. 1. One color sensor 20 may be configured to detect the spectrum signals and brightness signals of the two upper transparent display modules 10, i.e., in regions A and B. The other color sensor 20 may be configured to detect the spectrum signals and brightness signals of the two lower transparent display modules 10, i.e., in regions C and D.

In some embodiments, referring to FIG. 1, at least two color sensors 20 and at least two transparent display modules 10 may be included in the display device. Each color sensor 20 may correspond to a transparent display module 10 and may form a one-to-one correspondence with the transparent display module 10. That is, each color sensor 20 may detect the spectrum signals and brightness signals of the corresponding transparent display module 10.

Specifically, referring to FIG. 1, the exemplary display device may include four jointly-connected transparent display modules 10. The four transparent display modules 10 may be positioned in regions A, B, C, and D, respectively. Each transparent display module 10 may correspond to one color sensor 20. Each color sensor 20 may be configured to detect the spectrum signals and brightness signals of one corresponding transparent display module 10. Compared with one color sensor 20 detecting the spectrum signals and brightness signals of more than one transparent display modules 10, one color sensor 20 detecting the spectrum signals and brightness signals of only one transparent display module 10 may reduce duplicated detection of spectrum signals and brightness signals from other transparent display modules 10. That is, interference to the spectrum signals and brightness signals of one transparent display module 10, caused by the detection of spectrum signals and brightness signals of other transparent display modules 10, may be reduced. Thus, accuracy and reliability of the detection of the spectrum signals and brightness signals, by the color sensors 20, may be improved.

Referring to FIG. 1, in some embodiments, each color sensor 20 may be disposed on one peripheral side of the corresponding transparent display module 10. For example, as shown in FIG. 1, a color sensor 20 may be disposed on the peripheral side of the corresponding transparent display module 10 such that the color sensor 20 would not occupy an area on the light incident side or the light emitting side of the corresponding transparent display module 10. Thus, a color sensor 20 would not block the backlight radiating on the corresponding transparent display module 10, nor would block the light emitted by the corresponding transparent display module 10. The color sensors 20 may be arranged on a same peripheral side or different peripheral sides of the transparent display modules 10.

In some embodiments, the color sensors 20 may be positioned on the same peripheral side of the transparent display modules 10, so that the detecting part of each color sensor 20 may face a same direction. The detecting part of a color sensor 20 may refer to a part or portion of the color sensor 20 used for collecting and detecting light. For example, as shown in FIG. 1, the color sensor 20 corresponding to the transparent display module 10 positioned at region A may be disposed on the upper peripheral side of the transparent display module 10 positioned at region A; the color sensor 20 corresponding to the transparent display module 10 positioned at region B may be disposed on the upper peripheral side of the transparent display module 10 positioned at region B; the color sensor 20 corresponding to the transparent display module 10 positioned at region C may be disposed on the upper peripheral side of the transparent display module 10 positioned at region C; and the color sensor 20 corresponding to the transparent display module 10 positioned at region D may be disposed on the upper peripheral side of the transparent display module 10 positioned at region D. The detecting part of the four color sensors 20 may face downwardly, as shown in FIG. 1.

It should be noted that, a color sensor 20 may also be arranged on another peripheral side of the corresponding transparent display module 10. For example, a color sensor 20 may be arranged at the bottom/lower peripheral side of the corresponding transparent display module 10. It is, however, required that the color sensors 20 do not block the backlight incident on the corresponding transparent display module 10 nor block the light emitted by the corresponding transparent display module 10. In some embodiments, all the color sensors 20 may be arranged on the same peripheral side of the corresponding transparent display modules 10, e.g., all the color sensors 20 may be arranged on the upper or lower peripheral side of the corresponding transparent display module 10. The specific arrangement of the color sensors 20 should be determined according to specific applications and designs and should not be limited by the embodiments of the present disclosure.

To further improve the accuracy and reliability of the detection by the color sensors, a lens may be disposed between a color sensor and the transparent display modules. As shown in FIG. 2, a directional lens 21 may be disposed between the color sensor 20 and the transparent display modules 10. Through the directional lens 21, a color sensor 20 may detect only the spectrum signals and brightness signals of the corresponding transparent display module 10.

For example, referring to FIG. 1, the display device may be formed by four jointly-connected transparent display modules 10. A color sensor 20 may be disposed on the upper peripheral side of each transparent display module 10, and a directional lens 21, as shown in FIG. 2, may be arranged between a color sensor 20 and the corresponding transparent display module 10. A color sensor 20 and the corresponding directional lens 21 may form a directional color sensor. When a directional color sensor, formed by a color sensor 20 and the corresponding directional lens 21, detects the spectrum signals and brightness signals of the corresponding transparent display module 10, the directional lens 21 may allow the color sensor 20 to detect only the spectrum signals and brightness signals of the corresponding transparent display module 10. The directional color sensor thus does not detect the spectrum signals and brightness signals of other transparent display modules 10. A directional lens 21 may also condense the incident light and increase the detectable angle of the corresponding directional color sensor. Accordingly, a directional lens 21 may further improve the detection accuracy and reliability of the corresponding directional color sensor in detecting the spectrum signals and brightness signals. A directional lens 21 may be a convex lens, a concave lens, or other suitable lenses.

For the controller to adjust the image signals of each transparent display module 10 individually or separately, the disclosed display device may further include an image signal processing circuit. The image signal processing unit may be connected to the controller. In some embodiments, the image signal processing circuit may be included or integrated in the controller. The image signal processing circuit may be connected to each transparent display module 10. The controller may send proper image signal processing parameters to the image signal processing circuit. The image signal processing circuit may be configured to adjust the image signals for each transparent display module 10.

For example, referring to FIG. 1, the display device may be formed by four jointly-connected transparent display modules 10. A color sensor 20 may be disposed on the upper peripheral side of each transparent display module 10. Each color sensor 20 may be connected to the controller through a control signal line. An image signal processing circuit, connected to the controller, may be disposed in the display device. The image signal processing circuit may be connected to each transparent display module 10. Based on the spectrum signals and brightness signals of each transparent display module 10, detected by the corresponding color sensor 20, the controller may calculate the image signal processing parameters, of each transparent display module 10 for adjusting the image signals of the transparent display module 10. The controller may adjust the image signals for each transparent display module 10 separately through the image signal processing circuit.

For example, based on the spectrum signals and brightness signals of each transparent display module 10, detected by the corresponding color sensor 20, the controller may calculate the image signal processing parameters of the transparent display module 10 positioned at region C for adjusting the image signals of the transparent display module 10. The controller may send the image signal processing parameters for the transparent display module 10 to the image signal processing circuit. The image signal processing circuit may adjust the image signals for the transparent display module 10 positioned at region C based on the image signal processing parameters. The adjusting of the image signals of other transparent display modules 10 may be implemented through a same process for adjusting the image signals of the transparent display module 10 positioned at region C, as described above. Thus, the controller may separately or individually adjust the image signals of each transparent display module 10.

In some embodiments, one image signal processing circuit may be arranged in the display device. The controller may adjust image signals for a plurality of transparent display modules 10 separately through the one image signal processing circuit. In some other embodiments, a plurality of image signal processing circuits may be arranged in the display device. In this case, each image signal processing circuit may be configured to adjust the image signals of one transparent display module 10. The number of image signal processing circuits used in the display device should be determined according to different applications and should not be limited by the embodiments of the present disclosure.

In some embodiments, at least two image signal processing circuits and at least two transparent display modules 10 may be included in the display device and connected to the controller. The image signal processing circuits and the transparent display modules 10 may form a one-to-one correspondence. Each image signal processing circuit may be connected to the controller and the corresponding transparent display module 10. The controller may send the image signal processing parameters for each transparent display module 10 to the image signal processing circuit corresponding to the transparent display module 10. The controller may adjust the image signals of a transparent display module 10 through the corresponding image signal processing circuit.

In practice, referring to FIG. 1, the display device may be formed by four jointly-connected transparent display modules 10. A color sensor 20 may be disposed on the upper peripheral side of each transparent display module 10. Each color sensor 20 may be connected to the controller through a control signal line. Each transparent display module 10 may correspond to an image signal processing circuit. Each image signal processing circuit may be connected to the controller and the corresponding transparent display module 10.

FIG. 10 illustrates an exemplary block diagram of certain parts and related signal flows between the parts. For illustrative purposes, only one color sensor, one image signal processing circuit, and two transparent display modules are shown. in some embodiments, two or more color sensors may be included in the display device, each color sensor corresponding to a transparent display module. In some embodiments, two or more image signal processing circuits may be included in the display device, forming one-to-one correspondence with the transparent display modules.

In an exemplary adjustment process, the color sensor may detect the spectrum signals and brightness signals of each transparent display module and send the detected signals to the controller. The controller may receive the spectrum signals and brightness signals, perform certain calculations based on the received signals, and determine the image signal processing parameters for each transparent display module. Further, the controller may send the image signal processing parameters for each transparent module to the image signal processing circuit. The image signal processing circuit may adjust the image signal of each transparent display module based on the image signal processing parameters for each transparent display module.

In operation, for example, based on the spectrum signals and brightness signals of each transparent display module 10, detected by the corresponding sensor 20, the controller may calculate the image signal processing parameters of the transparent display module 10 positioned at one region such as region C for adjusting the image signals. Further, the controller may send the image signal processing parameters to the image signal processing circuit corresponding to the transparent display module 10 so that the image signal processing circuit may adjust image signals on the transparent display module 10 positioned at region C.

By arranging a plurality of image signal processing circuits in the display device, each image signal processing circuit may correspond to a transparent display module 10 to adjust the image signals of the corresponding transparent display module 10. Compared to a display device with on, image signal processing circuit to adjust the image signals of more than one transparent display modules 10, a display device with a plurality of image signal processing circuits, each corresponding to a transparent display module 10, may prevent interference between the image signal processing parameters between different transparent display modules 10. The adjusting of the image signals of the transparent display modules 10 may provide improved reliability and accuracy.

In the present disclosure, the image signals for a transparent display module 10 may include the signals that control the white balance, brightness, and color of the transparent display module 10. The image signal processing parameters for adjusting the image signals of one transparent display module 10 may include white balance adjustment parameters, brightness adjustment parameters, and color adjustment parameters. Accordingly, the image signal processing circuits may include white balance adjustment circuits, brightness adjustment circuits, and color adjustment circuits. Different types of image signal processing circuits may be independent from each other. An image signal processing circuit may include a white balance adjustment circuit, a brightness adjustment circuit, and a color adjustment circuit, each being independent from one another. White balance adjustment circuits may be configured to adjust the white balance of a transparent display module 10. Brightness adjustment circuits may be configured to adjust the brightness of a transparent display module 10. Color adjustment circuits may be configured to adjust the color of a transparent display module 10. Other suitable circuits may also be included and details are not repeated herein. The process of an image signal processing circuit to adjust the corresponding image signals may be referred to the description of FIGS. 3-5 and is not repeated herein.

Referring to FIG. 1, the disclosed display device may further include a light guide plate 40. The light guide plate 40 may be arranged on the light incident side of the transparent display modules 10. In practice, with the light guide plate 40 being on the light incident side of the transparent display modules 10, the light source 30 may be arranged. on one or more of the peripheral sides of the light guide plate 40. In operation, the light guide plate 40 may guide the light from the light source 30 to each transparent display module 10 to reduce backlight leakage. The backlight from the light source 30 may be used more efficiently. The backlight intensity incident on each transparent display module 10 may be increased accordingly.

Another aspect of the present disclosure provides a method for using or operating a display device. FIGS. 6-8 each illustrates an exemplary process of the disclosed method used in different embodiments.

As shown in FIG. 6, the method may include steps S601-S603.

In step S601, color sensors may detect the spectrum signals and brightness signals of each transparent display module.

In step S602, based on the detected spectrum signals and brightness signals of each transparent display module, the controller may obtain the image signal processing parameters for adjusting image signals of each transparent display module.

In step S603, the controller may adjust the image signals of each transparent display module based on the corresponding image signal processing parameters.

It should be noted that, the embodiments of the present disclosure are described in a progressive manner. The similarities or common features in embodiments may not be repeatedly described. Each embodiment highlights the difference from other embodiments. Particularly, because the embodiments for illustrating the method can be referred to the embodiments used for describing the display device, the description of the method is simplified. Detailed description of the method may be referred to previous embodiments for the display device and is not repeated herein.

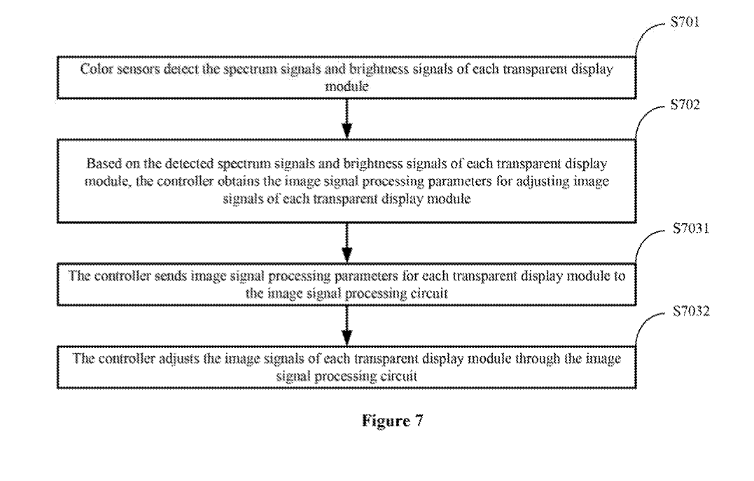

FIG. 7 illustrates another exemplary process of the method for operating the display device. The process shown in FIG. 7 may include steps S701-S703, where step S703 may include steps S7031 and S7032. Step S701 may be the same as or similar to step S601, and step S702 may be the same as or similar to step S602.

In some embodiments, the display device may include an image signal processing circuits. The image signal processing circuit may be connected to the controller, and may be connected to each transparent display module. Compared to the process illustrated in FIG. 6, step S703 may include steps S703 and S7032.

In step S7031, the controller may send image signal processing parameters for each transparent display module to the image signal processing circuit.

In step S7032, the controller may adjust the image signals of each transparent display module through the image signal processing circuit.

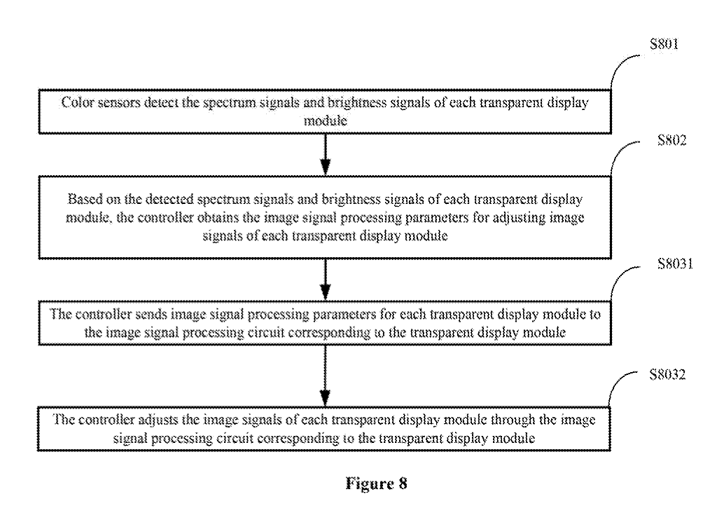

FIG. 8 illustrates another exemplary process of the method for operating the display device. The process shown in FIG. 8 may include steps S801-S803, where step S803 may include steps S8031 and S8032. Step S801 may be the same as or similar to step S601, and step S802 may be the same as or similar to step S602.

In some embodiments, at least two image signal processing circuits and at least two transparent display modules may be arranged in the display device. The image signal processing circuits may form one-to-one correspondence with the transparent display modules. Each image signal processing circuit may be connected to the controller and the corresponding transparent display module. Compared to the process illustrated in FIG. 6, step S803 may include steps S8031 and S8032.

In step S8031, the controller may send image signal processing parameters for each transparent display module to the image signal processing circuit corresponding to the transparent display module.

In step S8032, the controller may adjust the image signals of each transparent display module through the image signal processing circuit corresponding to the transparent display module.

In the embodiments described above, whenever possible, the features, structures, materials, or properties of one embodiment may also be applied in combination or independently in other embodiments.

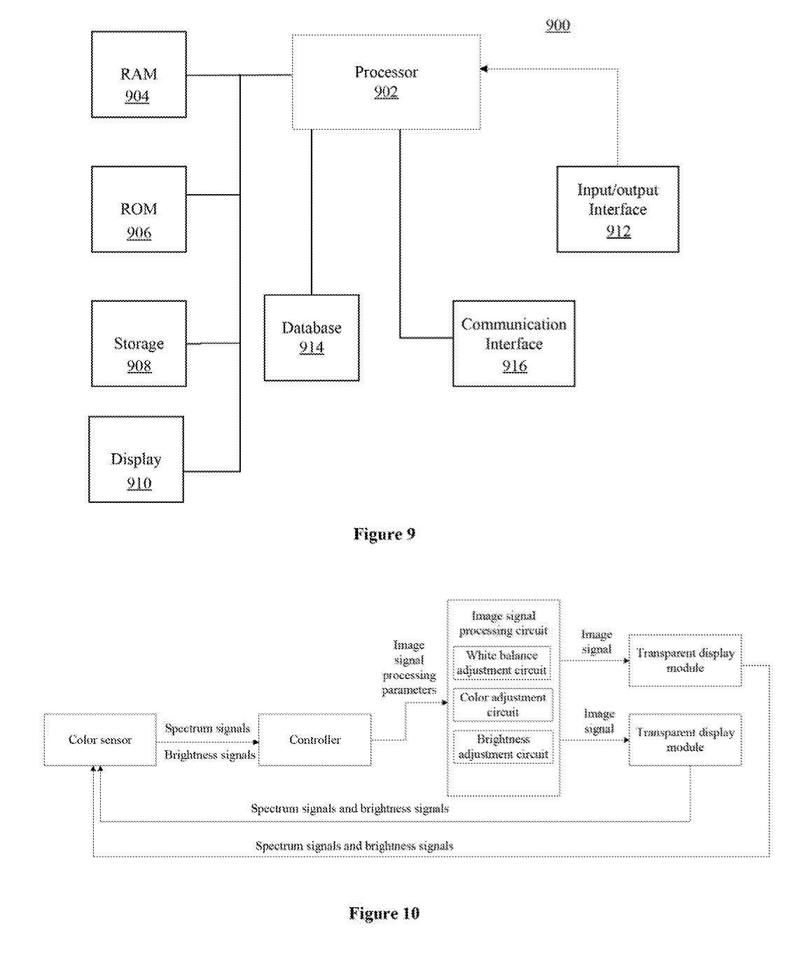

FIG. 9 illustrates a block diagram of the controller used in various disclosed embodiments of the present disclosure.

The controller 900 may receive, process, and execute commands from the display device. The controller 900 may include any appropriately configured computer system for operating the display device. As shown in FIG. 9, controller 900 may include a processor 902, a random access memory (RAM) 904, a read-only memory (ROM) 906, a storage 908, a display 910, an input/output interface 912, a database 914; and a communication interface 916. Other components may be added and certain components/devices may be removed without departing from the principles of the disclosed embodiments.

Processor 902 may include any appropriate type of general purpose microprocessor, digital signal processor or microcontroller, and application specific integrated circuit (ASIC). Processor 902 may execute sequences of computer program instructions to perform various processes associated with controller 900. Computer program instructions may be loaded into RAM 904 for execution by processor 902 from read-only memory 906, or from storage 908. Storage 908 may include any appropriate type of mass storage provided to store any type of information that processor 902 may need to perform the processes. For example, storage 908 may include one or more hard disk devices, optical disk devices, flash disks, or other storage devices to provide storage space.

Display 910 may provide information to a user or users of the controller 900. Display 910 may include any appropriate type of computer display device or electronic device display (e.g., CRT or LCD based devices). Input/output interface 912 may be provided for users to input information into controller 900 or for the users to receive information from controller 900. For example, input/output interface 912 may include any appropriate input device, such as a keyboard, a mouse, an electronic tablet, voice communication devices, touch screens, or any other optical or wireless input devices. Further, input/output interface 912 may receive from and/or send to other external devices.

Further, database 914 may include any type of commercial or customized database, and may also include analysis tools for analyzing the information in the databases. Database 914 may be used for storing information for generating image signal processing parameters. Communication interface 916 may provide communication connections such that controller 900 may be accessed remotely and/or communicate with other systems through computer networks or other communication networks via various communication protocols, such as transmission control protocol/internet protocol (TCP/IP), hyper text transfer protocol (HTTP), etc.

In one embodiment, the controller 900 may obtain spectrum signals and brightness signals of transparent display modules from the color sensors through the input/output interface 912. The processor 902 may obtain commands from the RAM 904, the storage 908, and/or the ROM 906, and calculate the proper image signal processing parameters for each transparent display module based on the collected data and certain algorithm stored in the data base 914. The controller 900 may be connected to least one image signal processing circuit, which is connected to each transparent display module. The controller 900 may send the image signal processing parameters to the image signal processing circuits through the input/output interface 912 and adjust the image signals of the transparent display modules. The result can be returned to the user via the display 910 or the input/output interface 912. The display 910 may be a transparent display module, an opaque display module, or any suitable display device.

It should be understood that the above embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

1-14. (canceled)

15. A display device, comprising:
at least two display modules connected jointly;
a controller; and
at least one color sensor for detecting spectrum signals and brightness signals of each display module, wherein:
the controller is configured to receive the spectrum signals and brightness signals of each display module and provide image signal processing parameters for each display module.

16. The display device according to claim 15, further comprising:
at least one image signal processing circuit connected to the controller and the at least two display modules, wherein the at least one image signal processing circuit is configured to receive image signal processing parameters from the controller and adjust the image signals of each display module.

17. The display device according to claim 16, further comprising at least two image signal processing circuits, the at least two display modules and the at least two image signal processing circuits forming a one-to-one correspondence, wherein:
each image signal processing circuit is connected to a corresponding display module; and
each of the image signal processing circuits is configured to receive image signal processing parameters from the controller and adjust the image signals of the corresponding display module.

18. The display device according to claim 16, wherein:
the image signal processing circuit includes a white balance adjustment circuit, a brightness adjustment circuit, and a color adjustment circuit, being independent from one another, the white balance adjustment circuit adjusting red/green/blue gains of a display module, the brightness adjusting a brightness value of a display module, and the color adjustment Circuit adjusting a color value of a display module.

19. The display device according to claim 16, wherein the at least two display modules include at least a transparent display module.

20. The display device according to claim 19, further comprising:
a directional lens between a color sensor and a display module, the color sensor detects the spectrum signals and brightness signals of the display module.

21. The display device according to claim 19, wherein a detecting part of each color sensor faces a same direction.

22. The display device according to claim 19, wherein the spectrum signals and brightness signals of each display module detected by the at least one color sensor are generated by each display module in response of backlight of the display device.

23. The display device according to claim 19, further comprising at least two color sensors forming a one-to-one correspondence with the at least two display modules, wherein each color sensor detects the spectrum signals and brightness signals of a corresponding display module.

24. The display device according to claim 23, wherein:
a color sensor is arranged on a peripheral side of the corresponding display module.

25. The display device according to claim 24, wherein:
color sensors are arranged on a same peripheral side of the corresponding display modules.

26. The display device according to claim 15, further comprising a backlight module having a light guide plate, wherein the light guide plate arranged on a light incident side of the at least two display modules.

27. The display device according to claim 26, the backlight module further comprising a light source, wherein:
the light source is disposed on one or more peripheral sides of the light guide plate; and the
light source includes a plurality of lighting stripes formed by dot-shaped illuminators.

28. A method for operating the display device according to claim 15, comprising:
detecting spectrum signals and brightness signals of each transparent display module;
based on the detected spectrum signals and brightness signals of each transparent display module, obtaining image signal processing parameters of each transparent display module for adjusting image signals of each transparent display module; and
based on the image signal processing parameters of each transparent display module, adjusting the image signals of each transparent display module.
